(19) United States
(12) Patent Application Publication
(10) Pub. No.: US 2010/0019652 A1
(43) Pub. Date: Jan. 28, 2010

(54) ELECTRON EMISSION DEVICE AND LIGHT EMISSION DEVICE INCLUDING THE SAME

(76) Inventors: So-Ra Lee, Suwon-si (KR); Jae-Myung Kim, Suwon-si (KR); Yoon-Jin Kim, Suwon-si (KR); Hee-Sung Moon, Suwon-si (KR); Kyu-Nam Joo, Suwon-si (KR); Hyun-Ki Park, Suwon-si (KR)

Correspondence Address: CHRISTIE, PARKER & HALE, LLP, PO BOX 7068, PASADENA, CA, 91109-7068, US

(21) Appl. No.: 12/493,042

(22) Filed: Jun. 26, 2009

(30) Foreign Application Priority Data
Jul. 22, 2008 (KR) 10-2008-0071208

(51) Int. Cl. H01J 1/62; H01J 19/40

(52) U.S. Cl. 313/495; 313/313

(57) ABSTRACT

An electron emission device includes a substrate; first electrodes on the substrate and spaced apart from each other in a first direction; a second electrode electrically insulated from the first electrodes and extending in a second direction crossing the first direction; and electron emitters located on sides of each of the first electrodes.

### CROSS-REFERENCE TO RELATED PATENT APPLICATIONS

This application claims priority to and the benefit of Korean Patent Application No. 10-2008-0071208, filed on Jul. 22, 2008, in the Korean Intellectual Property Office, the disclosure of which is incorporated herein in its entirety by reference.

### BACKGROUND OF THE INVENTION

1. Field of the Invention

The present invention relates to an electron emission device and a light emission device including the same.

2. Description of the Related Art

A light emission device can be defined as any device that externally emits recognizable light. A conventional light emission device includes a top substrate including anode electrodes and a fluorescent layer and a bottom substrate including electron emission parts and driving electrodes. Edges of the top and bottom substrates are integrally coupled to each other by a sealing member, and vacuum is generated in the inner space, and thus, the top and bottom substrates and the sealing member constitute a vacuum container.

In some conventional light emission devices, a driving electrode includes a cathode electrode and a gate electrode parallel to the cathode electrode, and an electron emission device can be on a side surface of the cathode electrode facing the gate electrode. The driving electrode and the electron emission part constitute an electron emission unit.

The anode electrode is disposed on a surface of the fluorescent layer facing the bottom substrate, thereby constituting a light emission unit, together with the fluorescent layer.

The conventional light emission device is driven by applying a predetermined driving voltage to the cathode electrode and the gate electrode and a positive direct current voltage of thousands of volts, that is, an anode voltage, to the anode electrode. An electric field is thereby formed around the electron emission part due to a difference between a voltage of the cathode and a voltage of the gate electrode, and electrons are thereby emitted. The emitted electrons are attracted due to the anode voltage and collide with a corresponding portion of the fluorescent layer to thereby emit light.

When light emission devices are driven by applying a predetermined voltage to the cathode electrode and the gate electrode, electron emission devices disposed in a row concurrently emit electrons for light emission. In addition, the cathode electrode and the gate electrode are disposed on the same layer. Due to these reasons, for light emission devices, screen-division driving, or in other words, local dimming, is difficult to accomplish.

### SUMMARY OF THE INVENTION

Exemplary embodiments of the present invention provide an electron emission device in which local dimming is made possible by utilizing a separate electrode insulated from a cathode electrode, and a light emission device including the electron emission device.

According to an aspect of an exemplary embodiment of the present invention, there is provided an electron emission device including: a substrate; first electrodes on the substrate and spaced apart from each other in a first direction; a second electrode electrically insulated from the first electrodes and extending in a second direction crossing the first direction; and electron emitters located on sides of each of the first electrodes.

In the electron emission device, a gap may be between adjacent ones of the electron emitters.

In the electron emission device, the electron emitters may be thinner than the first electrodes.

In the electron emission device, the electron emitters may include carbide-derived carbon.

According to another aspect of an exemplary embodiment of the present invention, there is provided a light emission device including: a first substrate and a second substrate facing the first substrate; an electron emission unit including a plurality of electron emission devices on a surface of the second substrate; and a light emission unit including a third electrode on the first substrate and a fluorescent layer on a side of the third electrode facing the second substrate, wherein each of the electron emission devices includes: first electrodes spaced apart from each other in a first direction; a second electrode electrically insulated from the first electrodes and extending in a second direction crossing the first direction; and electron emitters located on sides of each of the first electrodes.

In the light emission device, a portion of the fluorescent layer corresponding to one of the electron emission devices may be configured to emit light when the electron emitters emit electrons in accordance with voltages applied to the first electrodes and the second electrode.

The light emission device may further include interconnection lines for supplying an electric current to the first electrodes, wherein the interconnection lines are substantially perpendicular to the second electrode.

In the light emission device, a gap may be between adjacent ones of the electron emitters.

In the light emission device, the electron emitters may be thinner than the first electrodes.

In the light emission device, the electron emitters may include carbide-derived carbon.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial cross-sectional view of a light emission device including an electron emission device, according to an embodiment of the present invention;

FIG. 2 is a perspective view of the electron emission device of FIG. 1;

FIG. 3 is a plan view of an electron emission unit including a plurality of electron emission devices such as the one illustrated in FIG. 2; and

FIG. 4 is a partial cross-sectional view of a light emission device according to an embodiment of the present invention to explain how the light emission device is driven.

### DETAILED DESCRIPTION

Exemplary embodiments of the present invention will now be described more fully with reference to the accompanying drawings, so that the present invention may be more readily understood by one of ordinary skill in the art. The present invention may be embodied in various forms and is not limited to those embodiments that are described hereinafter.

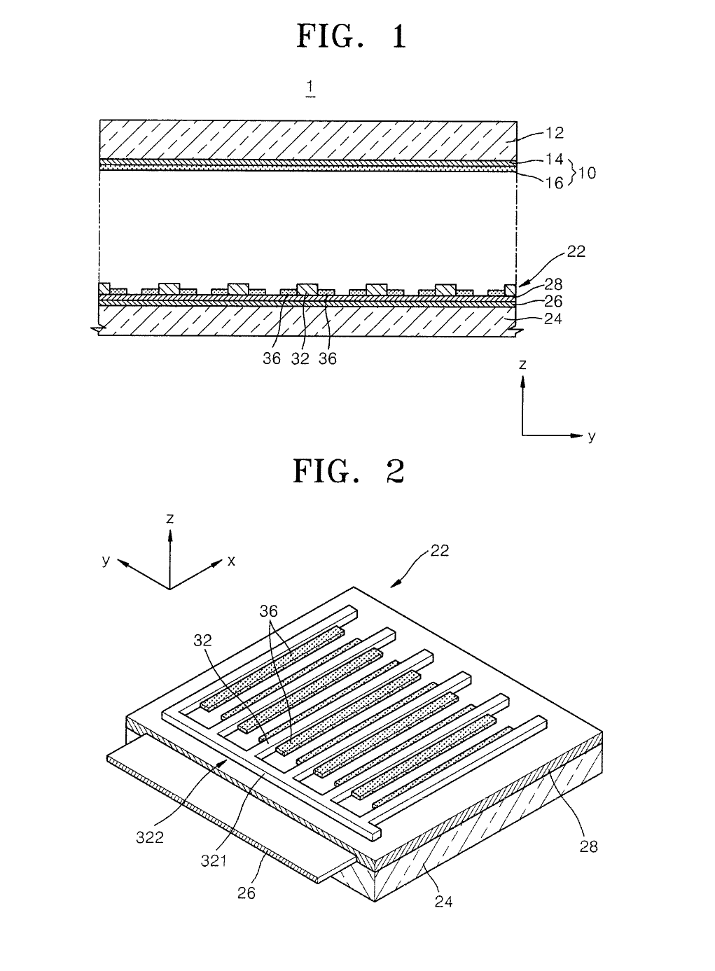

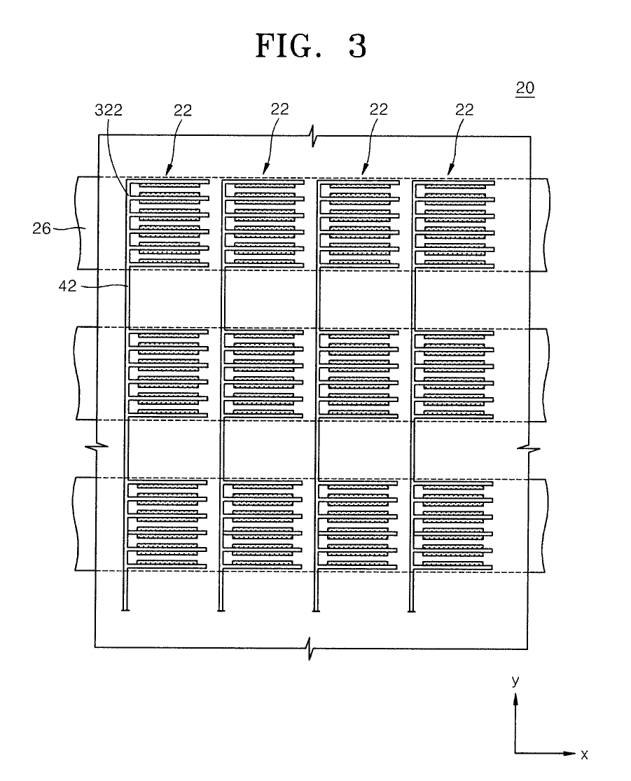

FIG. 1 is a partial cross-sectional view of a light emission device 1 including an electron emission device 22, according to an embodiment of the present invention, FIG. 2 is a perspective view of the electron emission device 22 of FIG. 1, and FIG. 3 is a plan view of an electron emission unit 20 including a plurality of electron emission devices 22, similar to the one illustrated in FIG. 2.

Referring to FIGS. 1 through 3, the light emission device 1 according to the current embodiment includes a first substrate 12 and a second substrate 24 positioned parallel to and spaced apart a distance from the first substrate 12. A sealing member (not shown) may be disposed on edges of the first substrate 12 and second substrate 24, so that the first and second substrates 12 and 24 are coupled to each other, and vacuum is generated in an inner space to a vacuum degree of about 10⁻⁶ torr. As a result, the first substrate 12, the second substrate 24, and the sealing member constitute a vacuum container.

In the first substrate 12 and the second substrate 24, a region surrounded by the sealing member may be divided into an effective region corresponding to areas utilized for emission of visible light, and a non-effective region surrounding the effective region. An electron emission unit 20 (see FIG. 3) for emitting electrons is disposed in the effective region of the second substrate 24, and a light emission unit 10 for emitting visible light is disposed in an effective region of the first substrate 12.

The electron emission unit 20 includes the electron emission devices 22, wherein emission currents of the electron emission devices 22 are individually controlled. The light emission unit 10 is disposed on the first substrate 12 and, when the light emission device 1 operates, receives electrons from the electron emission devices 22 on the second substrate 24 and emits visible light.

In the described embodiment, each of the electron emission devices 22 includes: a plurality of first electrodes 32 aligned in a direction coplanar with the second substrate 24, for example, an x-axis direction, and spaced apart a distance from each other and parallel to one another; and electron emission parts 36 respectively positioned on opposite side surfaces of each of the first electrodes 32. The electron emission parts 36 may be thinner than the electron emission devices 22.

Gaps may be formed between adjacent electron emission parts 36 disposed respectively on side surfaces of adjacent first electrodes 32 to prevent the electron emission devices 36 from short-circuiting. Due to the gaps, the electron emission parts 36 are spaced a distance (e.g., a predetermined distance) apart from each other.

The electron emission parts 36 may each be formed in a line pattern along the lengthwise direction of first electrodes 32, as illustrated in FIG. 2. In other embodiments, although not illustrated in FIG. 2, the electron emission parts 36 may alternatively be formed in other patterns, for example, discontinuously spaced apart from each other along the lengthwise direction of the first electrodes 32.

Referring to FIG. 2, a connecting electrode 321 is commonly connected to end portions of the first electrodes 32 and constitutes an electrode set 322 with the connected first electrodes 32.

The first electrodes 32 are disposed on the second substrate 24 and may be thicker than the electron emission parts 36. To accomplish this, the first electrodes 32 may be formed using a thin film forming process, such as a sputtering process or a vacuum deposition process, or a thick film forming process, such as a screen printing process or a laminating process. In addition, the first electrodes 32 may also be formed using other methods.

The electron emission parts 36 may include a material that emits electrons when an electric field is applied to the electron emission parts 36 in a vacuum condition. Such a material may be a carbonaceous material and/or a nanometer-sized material. For example, the electron emission parts 36 may include a material selected from the group consisting of carbon nanotubes, graphite, graphite nanofiber, diamond, diamond-like carbon, fullerene C₆₀, silicon nanowire, and combinations thereof.

In addition, the electron emission parts 36 may include carbide-derived carbon that can be manufactured by thermo-chemically reacting a carbide compound with a halogen atom-containing gas so that the carbide compound contains only carbon.

The carbide compound may include at least one carbide compound selected from the group consisting of SiC₄, B₄C, TiC, ZrCₓ, Al₄C₃, CaC₂, TiₓTa_{y}C, MoₓW_{y}C, TiNₓC_{y}, ZrNₓC_{y}, and combinations thereof. The halogen atom-containing gas may be Cl₂ gas, TiCl₄ gas, or F₂ gas. The electron emission parts 36 including the carbide-derived carbon may have excellent uniformity and a long lifetime.

In the present embodiment, the electron emission parts 36 may be formed using, for example, the screen printing process; however, the present invention is not limited thereto, and thus, the electron emission parts 36 may be formed using other methods.

In the electron emission unit 20 used in exemplary embodiments, screen division driving, that is, local dimming, may be more readily performed. To accomplish this, the electron emission device 22 further includes a second electrode 26. Specifically, the second electrode 26 is disposed on the second substrate 24 and extends in the x-axis direction. A dielectric layer 28 is disposed on the second electrode 26 and electrically insulates the second electrode 26 from the first electrodes 32. The first electrodes 32 are disposed on the dielectric layer 28. The local dimming performed by the second electrode 26 will be described below.

Referring to FIGS. 2 and 3, the electron emission devices 22 are consecutively aligned in the effective region of the second substrate 24. Interconnection lines 42 for applying a driving voltage to the first electrodes 32 of the electron emission devices 22 are disposed between the electron emission devices 22.

Here, the interconnection lines 42 are aligned in a direction coplanar with the second substrate 24, for example, a y-axis direction of FIG. 3, and are electrically connected to electrode sets 322 of electron emission devices 22 aligned in the same direction.

Although in FIG. 3 interconnection lines 42 electrically connected to the electron emission devices 22 are formed separately for neighboring electron emission devices 22 in the x direction in FIG. 3, the present inventive concept is not limited thereto. That is, first electrodes of an electron emission device and first electrodes of a neighboring electron emission device in the x direction may share one connecting electrode. In other words, the first electrodes of an electron emission device may be disposed on the left side of a connecting electrode and the first electrodes of a neighboring electron emission device may be disposed on the right side of the connecting electrode, for example, symmetrically along the connecting electrode. Accordingly, interconnection lines connected to the first electrodes of the neighboring electron emission devices need not be separately formed, and one interconnection line may be utilized for the first electrodes of neighboring electron emission devices.

Referring to FIG. 1, the light emission unit 10 includes a third electrode 14 on an inner surface of the first substrate 12 and a fluorescent layer 16 on a surface of the third electrode 14 facing the second substrate 24.

The fluorescent layer 16 may include mixed phosphors, including a red phosphor, a green phosphor, and a blue phosphor, to emit white light. The fluorescent layer 16 may be disposed in the entire effective region of the first substrate 12. The third electrode 14 may be applied with an anode voltage by a power source unit disposed outside the vacuum container and may function as an anode.

The third electrode 14 may be formed of a transparent conductive material, such as indium tin oxide (ITO), such that visible light emitted from the fluorescent layer 16 can pass therethrough.

The third electrode 14 may also be formed of aluminum. In this case, the third electrode 14 may be formed to have a very small thickness, for example, thousands of Å, and have micro holes through which electron beams pass.

Spacers (not shown) are disposed between the first substrate 12 and the second substrate 24 to resist pressure applied to the vacuum container and to maintain a substantially constant distance between the first substrate 12 and the second substrate 24.

In the light emission device 1, each of the electron emission devices 22 and a corresponding portion of the fluorescent layer 16 constitute one pixel. The light emission device 1 is driven by applying a driving voltage to the interconnection line 42 (see FIG. 3), an address voltage to the second electrode 26, and a positive direct current voltage of 10 kV or more, that is, an anode voltage, to the third electrode 14.

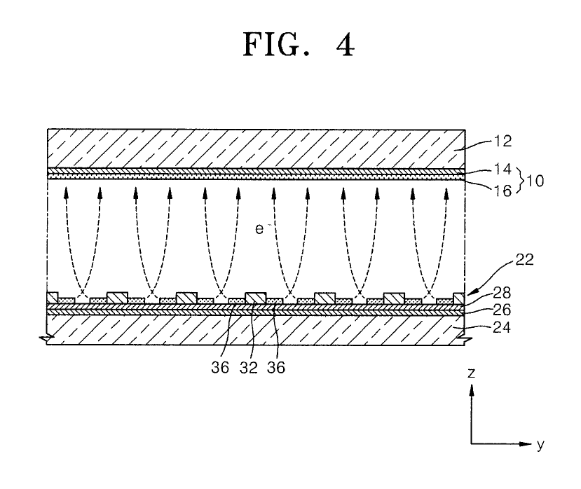

Therefore, some pixels, in which a difference between a voltage of the first electrodes 32 and a voltage of the second electrodes 26 is equal to or greater than a threshold value, are selected, an electric field is formed on the dielectric layer 28 between the first electrodes 32 and the second electrodes 26 of the selected pixels, and electrons (illustrated as e⁻ in FIG. 4) are emitted from the electron emission parts 36 of the selected pixels. The electrons emitted from the electron emission parts 36 due to the electric field formed between the first electrodes 32 and the second electrodes 26 are attracted due to the anode voltage and thus, collide with a corresponding portion of the fluorescent layer 16 to thereby emit light.

However, for regions where the address voltage is not applied or in which the difference between the voltage of the first electrodes 32 and the voltage of the second electrodes 26 is smaller than the threshold value, an electric field is not formed between the first electrodes 32 and the second electrodes 26 and thus electrons are not emitted from these electron emission devices 22. Accordingly, pixels corresponding to these electron emission devices 22 do not emit light.

FIG. 4 is a partial cross-sectional view of a light emission device 22 according to an embodiment of the present invention to explain how the light emission device 22 is driven.

Referring to FIG. 4, the light emission device 1 according to the current embodiment may be driven by applying a driving voltage to the first electrodes 32 and an address voltage to the second electrode 26. An electrode applied with a lower voltage among the driving voltage and the address voltage functions as a cathode electrode and an electrode applied with a higher voltage functions as a scan electrode. In one exemplary embodiment, the first electrodes 32 by which the electron emission parts 36 are formed function as the cathode electrodes and the second electrodes 26 functions as the scan electrodes.

When the driving voltage and the address voltage are applied, electrons (illustrated as e⁻ in FIG. 4) are emitted from the electron emission parts 36.

In the current embodiment, in the electron emission unit 20 (see FIG. 3), the first electrodes 32 corresponding to each interconnection line 42 are arranged perpendicular to the second electrodes 26 to provide local dimming. Specifically, when the driving voltage is applied to the first electrodes 32 and the address voltage is applied to the second electrode 26, electrons emitted from the electron emission parts 36 by the first electrodes 32 are attracted due to an anode voltage and collide with a corresponding portion of the fluorescent layer 16 to thereby emit light. Accordingly, some pixels corresponding to the selected electron emission devices 22 selectively emit light.

In other words, when a driving voltage is applied to the first electrodes 32 through the interconnection line 42 (see FIG. 3) of the electron emission unit 20 in a selected column, and an address voltage is applied to the second electrode 26 in a selected row, the first electrodes 32 in the selected column and the second electrode 26 in the selected row are selected. In this case, an electric field is formed in dielectric layer 28 between the first electrodes 32 and the second electrode 26, and thus, electrons are emitted from the electron emission parts 36 connected to the interconnection line 42. Meanwhile, for a column to which the address voltage is not applied or in which the difference between the voltage of the first electrodes 32 and the voltage of the second electrode 26 is smaller than a threshold value, an electric field is not formed and the light emission unit 10 does not emit light.

That is, since a row (in a y-axis direction of FIG. 3) in which a voltage applied to the first electrodes 32 and a column (in an x-axis direction of FIG. 3) in which a voltage applied to the second electrode 26 may be concurrently selected to determine pixels in which electrons are emitted for light emission, an electron emission device in which local dimming is possible and a light emission device including the electron emission device may be realized.

Meanwhile, the electron emission parts 36 may have smaller thicknesses than the first electrodes 32. In this case, the difference between a thickness of the first electrodes 32 and a thickness of the electron emission parts 36 may be about 1 μm to 10 μm. If the difference between the thickness of the first electrodes 32 and the thickness of the electron emission parts 36 is less than 1 μm, a shielding effect of an electric field due to the anode voltage is reduced and high voltage stability may be degraded, and thus, high luminosity, high efficiency, and a long lifetime may not be realized. On the other hand, if the difference between the thickness of the first electrodes 32 and the thickness of the electron emission parts 36 is more than 10 mm, the distance between a top surface of the first electrodes 32 and a top surface of the electron emission parts 36 is increased, and thus, the associated driving voltage may be increased.

In the latter case, on the second substrate 24, the first electrodes 32 that are thicker than the electron emission parts 36 change the electric field around the electron emission parts 36, and thus, the electron emission parts 36 are less affected by the electric field due to the anode voltage. By maintaining the thickness difference in the range of 1 μm to 10 μm, even when an anode voltage of 10 kV or more is applied to the third electrode 14 to improve the luminosity of a light emission surface, the first electrodes 32 may weaken the electric field due to the anode voltage and the electron emission parts 36, and thus, emission caused by the electric field due to the anode voltage may be effectively suppressed or reduced.

Accordingly, for the light emission device 1 according to exemplary embodiments, an anode voltage may be increased to improve the luminosity of a light emission surface, and emission may be suppressed to accurately control the luminosity of pixels. In addition, the light emission device 1 has high voltage stability, the generation of arcing in a vacuum container may be minimized or reduced, and inner structures may be protected from being damaged by the arcing.

As described above, an electron emission device in which local dimming is possible and a light emission device including the electron emission device may thus be realized.

Also, an electron emission device and light emission device according to embodiments of the present invention may be suitable for securing desired resistance.

Also, an electron emission device and light emission device according to embodiments of the present invention may be manufactured as large structures for use as a display panel.

Also, an electron emission device and light emission device according to embodiments of the present invention may be applied with a high voltage because the electrodes are thicker than the electron emission parts.

Also, an electron emission device and light emission device according to embodiments of the present invention may use an electron emission part formed by patterning a carbide-derived carbon, so that non-uniform emission performance is improved and a simpler cold cathode structure may be manufactured.

While the present invention has been shown and described with reference to exemplary embodiments thereof, it will be understood by those of ordinary skill in the art that various changes in form and details may be made without departing from the spirit and scope of the present invention as defined by the following claims and variations thereof.

What is claimed is:

1. An electron emission device comprising:
a substrate;
first electrodes on the substrate and spaced apart from each other in a first direction;
a second electrode electrically insulated from the first electrodes and extending in a second direction crossing the first direction; and
electron emitters located on sides of each of the first electrodes.

2. The electron emission device of claim 1, wherein a gap is between adjacent ones of the electron emitters.

3. The electron emission device of claim 1, wherein the electron emitters are thinner than the first electrodes.

4. The electron emission device of claim 3, wherein the electron emitters are between 1 μm and 10 μm thinner than the first electrodes.

5. The electron emission device of claim 1, wherein the electron emitters comprise carbide-derived carbon.

6. The electron emission device of claim 1, wherein the electron emitters are configured to emit electrons in accordance with voltages applied to the first electrodes and the second electrode.

7. The electron emission device of claim 6, wherein the electron emitters are configured to emit electrons when a voltage difference between the voltage applied to the first electrodes and the voltage applied to the second electrode is greater than a threshold voltage.

8. A light emission device comprising:
a first substrate and a second substrate facing the first substrate;
an electron emission unit comprising a plurality of electron emission devices on a surface of the second substrate; and
a light emission unit comprising a third electrode on the first substrate and a fluorescent layer on a side of the third electrode facing the second substrate,
wherein each of the electron emission devices comprises:
first electrodes spaced apart from each other in a first direction;
a second electrode electrically insulated from the first electrodes and extending in a second direction crossing the first direction; and
electron emitters located on sides of each of the first electrodes.

9. The light emission device of claim 8, wherein a portion of the fluorescent layer corresponding to one of the electron emission devices is configured to emit light when the electron emitters emit electrons in accordance with voltages applied to the first electrodes and the second electrode.

10. The light emission device of claim 9, wherein the electron emitters are configured to emit electrons when a voltage difference between the voltage applied to the first electrodes and the voltage applied to the second electrode is greater than a threshold voltage.

11. The light emission device of claim 8, further comprising interconnection lines for supplying an electric current to the first electrodes, wherein the interconnection lines are substantially perpendicular to the second electrode.

12. The light emission device of claim 11, wherein the first electrodes extend from corresponding interconnection lines in the second direction.

13. The light emission device of claim 8, wherein a gap is between adjacent ones of the electron emitters.

14. The light emission device of claim 8, wherein the electron emitters are thinner than the first electrodes.

15. The light emission device of claim 8, wherein the electron emitters comprise carbide-derived carbon.
